(19) United States
(12) Patent Application Publication
(10) Pub. No.: US 2002/0084334 A1
(43) Pub. Date: Jul. 4, 2002

(54) Digital electronic audio player with cassette tape simulation feature and compatible with cassette tape players, and method therefore

(76) Inventor: Franklin Zhigang Zhang, Torrance, CA (US)

Correspondence Address: Franklin Zhigang Zhang, 4808 Laurette Street, Torrance, CA, 90503, US

(21) Appl. No.: 10/034,939

(22) Filed: Dec. 28, 2001

Related U.S. Application Data
(60) Provisional application No. 60/259,507, filed on Jan. 3, 2001.

(51) Int. Cl. G06K 19/06

(52) U.S. Cl. 235/493

(57) ABSTRACT

A digital electronic audio player (DEAP) shaped similar to a cassette tape can be inserted into a cassette tape player such as a car cassette player. When the DEAP is inserted into a cassette player, the cassette tape play simulation and motion detection means sense the operation from the cassette player. When the play forward function of the cassette player is selected, the DEAP senses the operation from the player and plays the audio message in the memory; and output signal through the signal coupling magnetic head to the magnetic head of the cassette player just like a cassette tape. When the other functions (play backward, forward music search/fast forward, reverse music search/rewind etc.) are selected from the cassette player, the DEAP senses and dose the corresponding operations. The extension adaptor can be optionally mounted onto the digital electronic audio player, the new integrity works as one unit which has more memory, power supply and can communicate with a computer.

### CROSS-REFERENCE TO RELATED APPLICATIONS

This application claims the benefit of the Provisional Patent Application Ser. No. 60/259,507 filed Jan. 3, 2001.

### BACKGROUND

1. Field of Invention

The present invention relates to a digital electronic audio player. More particularly, a digital electronic audio player with cassette tape simulation feature and can be used as a cassette tape.

2. Description of Prior Art

It is known a cassette tape player is almost everywhere in modern life. Most family own more than one cassette player such as stereo system at living room, car stereo, walk-man player and etc. People play music and pre-record information daily with cassette players. The media for cassette player is magnetic cassette tape, which is made by a plastic box assembly with magnetic tape, two wheels and some other parts. The information is recorded on to and played back from the magnetic tape via magnetic read/write head of the cassette player.

It is also known, there are a lot of electronic audio players being used daily. These electronic audio players comprise electronic assembly of processor, audio processing chip, memory, and, some other IC and electronics. Music or other audio files are stored into the memory and played back by the audio processor. One of the most popular examples is the MP3 music player. The audio information is compressed into MP3 type of file, stored into the memory of the MP3 music player, decoded and played back by the MP3 audio processing chip. Internet makes it very easy for people to exchange MP3 type information. Because it is a digital data file, MP3 type music is very easy to be edited. In another word, people can edit their favor songs (information) into digital audio players and play. Thus it makes the MP3 music growing very fast day-by-day. Digital audio player has much better audio quality than the conventional cassette tape player.

However, in the prior arts of the cassette tape, tapes with prerecorded published information need to be bought from the stores. It is inconvenience to edit and record the favor songs into one tape by using family cassette players. After re-record, the music quality reduces. The magnetic tape will be misshapen after many times replay and cause distort of the audio quality and other problems. Any magnetic field can affect the content of a magnetic tape. In the art of the digital electronic audio player, non of them can be used as a cassette tape and take the advantage of well developed audio technology of cassette tape player.

### SUMMARY

In this invention, a digital electronic audio player shaped similar to a standard cassette tape can be inserted into a cassette tape player such as a car cassette player. The digital electronic audio player comprises a cassette tape wheels simulation and a wheel motion detection means; a magnetic head built into the digital electronic audio player at the location to couple the output signal from the audio circuit to the magnetic head of a cassette player; a connector's area. The connector's area comprises mounting connectors, power connector, and digital signal connector, to provide the memory, power extension and communication with computer. By detecting the motion of the tape wheels, the digital electronic audio player can simulate the corresponding features of the regular cassette tape.

The digital electronic audio player also comprises control buttons, speaker jack, microphone, and LCD. The digital electronic audio player can be used as a regular digital audio player when it is not used with the cassette player.

An extension adaptor is an electronic extension of the digital electronic audio player for providing more memory and power. The extension adaptor also is used to coordinate the communication between the digital electronic audio player and a computer.

### OBJECTS AND ADVANTAGES

Accordingly, several objects and advantages of my invention are:

1) The digital electronic audio player makes it possible that high quality digital music or audio information can be played in the conventional, well-developed cassette player audio system.

2) By computer and networking technology, users can very easily edit their favor music and audio information into the digital electronic audio player.

3) The music or audio information stored in the memory of the digital electronic audio player always remains the same high quality, thus to prevent from defect or distorted audio message due to mechanical or material problem the regular cassette tape.

4) The digital electronic audio player can also use like the regular digital electronic audio player.

5) Because a cassette tape player can play music or other audio information from the digital electronic audio player just like using a cassette tape, user can feel very convenient to use the DEAP of the current invention just like using regular cassette tape. Not extra operation is needed when apply the DEAP with the cassette player.

### BRIEF DESCRIPTION OF THE DRAWINGS

The forgoing features and advantages of the present invention can be appreciated more fully from the following description, with references to the accompanying drawings in which:

FIG. 1 is a three-dimensional sketch of the digital electronic audio player application according to one preferred embodiment of the present invention.

FIG. 2A is the front view of the digital electronic audio player of the present invention.

FIG. 2B is the rear view of the digital electronic audio player of the present invention.

FIG. 2C is a cut away inside view of the digital electronic audio player of the present invention taken along the line C-C-C of FIG. 2B.

FIG. 3A is the front view of the extension adaptor of the present invention.

FIG. 3B is a cut away inside view of the extension adaptor of the present invention taken along the line B-B-B of FIG. 3A.

FIG. 4 is a schematic block representation of the system function of the electronic digital audio player and extension adaptor with a typical radio cassette player.

FIG. 5 is a flow chart representation of the operation of the digital electronic audio player of the present invention.

FIG. 6 is a flow chart representation of the operation of the digital electronic audio player working at the cassette tape simulation mode with the present invention.

### DESCRIPTION—PREFERRED EMBODIMENT

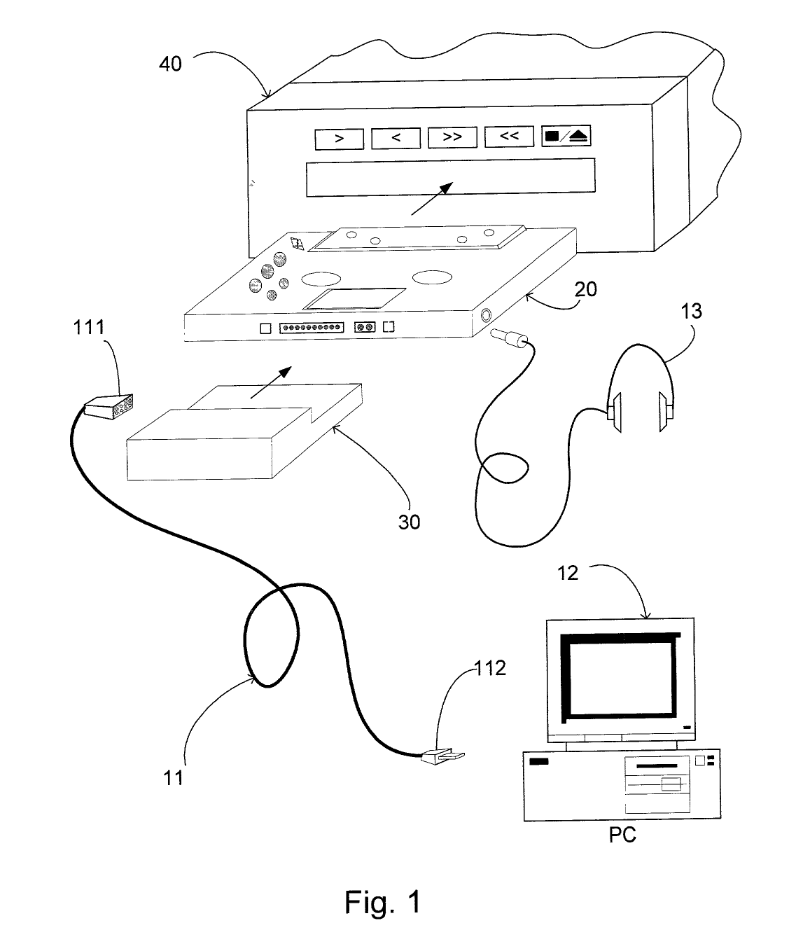

FIG. 1 is a three-dimensional sketch of the digital electronic audio player (DEAP) application according to one preferred embodiment of the present invention. As shown, a digital electronic audio player 20 of the present invention has the shape similar to a regular cassette tape. Thus, it can be inserted into a cassette player just like the cassette tape. More particular, a car cassette recorder 40 is shown in this embodiment. The digital electronic audio player 20 of the present invention can work as a regular digital electronic audio player as well. For example, when adopting the MP3 digital audio technology, the digital electronic audio player 20 of the present invention can work just like a regular MP3 player. It can play the music to the head set speakers 13. Also shown, the extension adaptor 30 can be attached onto the digital electronic audio player 20 to provide additional memory; power and connectivity to the computer 12 for download or upload the audio files and function setting. A communication cable 11 is needed to link the computer 12 and extension adaptor 30 together. More particular, the communication cable 11 has an industrial standard connector 112 such as USB or IEEE1394 connected to the computer while the other end 111 is connected to the extension adaptor 30. The communication is not limited to USB or IEEE1394 standard. It's possible for the computer and the extension adaptor to communicate with each other via wireless link.

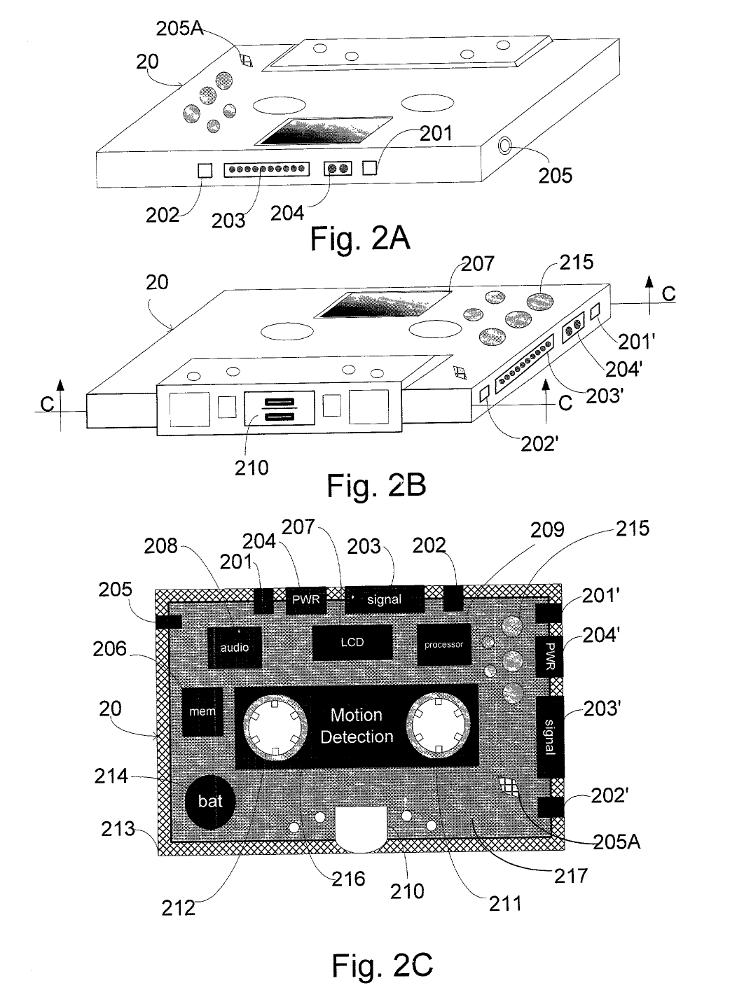

FIG. 2A is the front view of the digital electronic audio player of the present invention. FIG. 2B is the rear view of the digital electronic audio player of the present invention. FIG. 2C is a cut away inside view of the digital electronic audio player of the present invention taken along the line C-C-C of FIG. 2B.

As shown in the embodiments, the DEAP 20 comprises many elements. The extension connector's area comprises digital signal connector 203, the power connector 204 and two mounting structures 201,202. The DEAP 20 may comprises one additional extensional connector's area 201′, 202′, 203′, 204′ for easy use. Connecting with the extension adaptor via the digital signal connector 203 or 203′, the DEAP 20 can communicate with a computer for file transfer.

The power extension connector 204 or 204′ can be connected with an external DC power resource for additional power supply. LCD 207 is used to display the operating information. Audio output jack 205 and microphone 205A perform the regular audio application of the DEAP 20. The control button area 215 comprises multiple buttons for the DEAP 20 to be operated as a regular player. Also as shown in the FIG. 2B, the rear side of the DEAP 20 has a fully dimensional compatible with the regular cassette tape. The audio signal generated by the electronic circuit is sent to the magnetic head 210, which can couple the signal to the magnetic head of the cassette player 40. Thus the magnetic head of the cassette player picks up the signal just like reading from the regular cassette tape.

As shown in the FIG. 2C, the enclosure 213 is shaped similar to a cassette tape. The PCB assembly 217 of the DEAP 20 comprises all the function units to be a regular digital electronic audio player. Processor 209 controls all the operations. Memory 206 stores the operating system and audio files. Control buttons unit 215 and LCD 207 can be used to control and display the operation of the DEAP 20. Audio unit 208 is the special circuit for decoding the audio files and compressing the recorded voice The decoded audio file is outputted to magnetic head 210, which can be coupled to the magnetic head of the cassette player, and the head set speaker jack 205, to which a head set speaker can be plugged in. Audio information for record can be picked up via the microphone 205A. The magnetic head 210 can also be use as the source for audio information to be recorded.

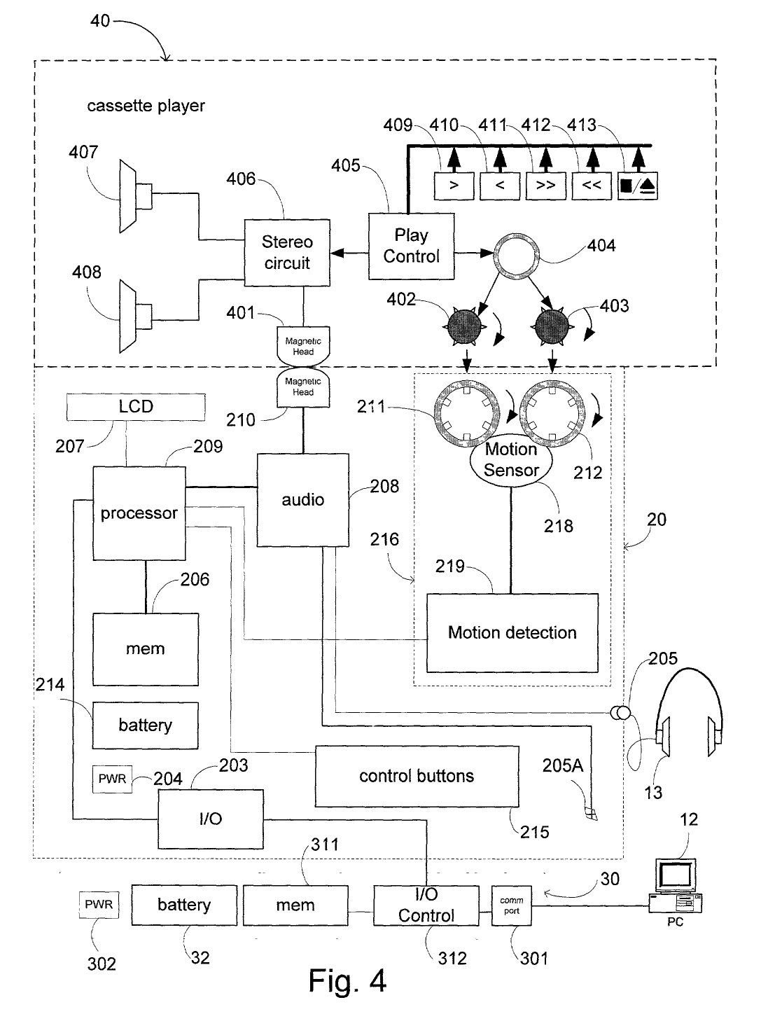

The key to simulate the operation of a cassette tape is the motion detection mechanism 216, which can detect the movement of the tape wheels 211,212. They are described detail in FIG. 4. As shown, the battery 214 on the PCB is a power resource for the DEAP 20 operation. Obviously, the duration time of the operation is limited by the capacity of the battery 214. The power extension connector 204, 204′ can be used to provide extra power for long time operation. I/O port 203 provides the digital signal connectivity for communication with computer and memory expansion.

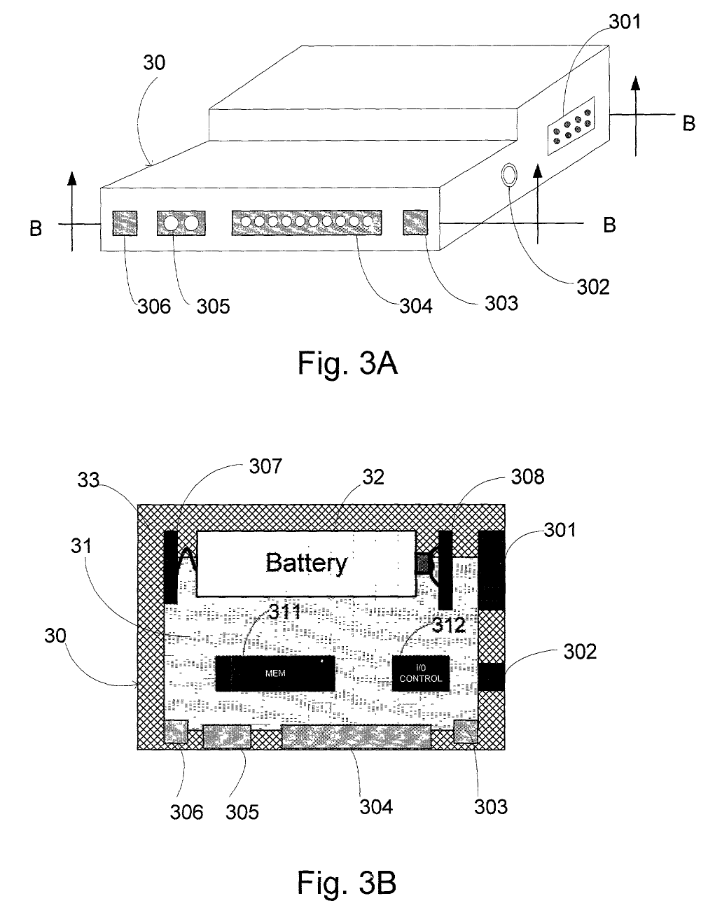

FIG. 3A is the front view of the extension adaptor of the present invention. FIG. 3B is a cut away inside view of the extension adaptor of the present invention taken along the line B-B-B of FIG. 3A. The extension adaptor 30 is designed for two purposes of providing connectivity to communicate with computer; and providing additional memory and power supply for the DEAP 20. The extension connectors area comprises the digital signal connector 304 which can be connected with the digital signal connector 203, 203′ of the DEAP 20; the power extension connector 305, which can be connected with the power extension connector 204, 204′ of the DEAP 20; the mounting structures of 303,306, which can be couple connected with the mounting structures 201&202 or 201′&202′ of the DEAP 20. A DC power can be provided to the extension adaptor 30 via its power connector 302. A communication cable can be connected to the communication port 301 to link the extension adaptor to a computer. The housing 33 is the enclosure of the extension adaptor. As shown, the extension adaptor 30 has a battery holder 307&308 for battery 32. The PCB 31 comprises memory 311, communication port 301 and I/O control circuit 312,which control the data communication between the DEAP 20 and computer 12.

FIG. 4 is a schematic block representation of the system function of the digital electronic audio player and extension adaptor with a typical radio cassette player. As shown in current embodiment, a typical cassette player comprises two speakers 407,408; stereo electronic circuit 406 for processing the signal picked up from the magnetic head 401; control buttons 409,410,411,412,413 allow user to control the operation of the cassette player 40 together with a cassette tape. The play control mechanism 405 controls the operation of the stereo electronic circuit 406 and the motor spin mechanism 404, which spins the tape spin axles 402 and 403. When button 409 or 410 is pushed, the cassette tape player works at play mode and spins the axles 402 and/or 403 at normal play speed. The stereo electronic circuit 406 works and processes any signal picked up for the magnetic head 401. When button 411 or 412 is pushed, the cassette tape player works at music search/fast forward or rewind mode and spin the axles 402 and/or 403 at high speed. The stereo electronic circuit 406 may or may not work at this mode depending on different types of the players. The stop button 413 is used to terminate the operations of the cassette player 40.

As shown in the embodiment, the motion detection mechanism 216 comprises motion detection circuit 219, which detects the motion from the motion sensor mechanism 218. The motion sensor mechanism 218 coordinates the spin of the two tape wheels 211 and 212 while providing the motion signal to motion detection circuit 219. Many sensor methods can be adapted to from the motion sensor unit 218. For example: the optical encoded tape and/or optical wheel can provide the motion with the optical pulse to the motion detection circuit 219.

Preferred Embodiment—Operation

FIG. 4 operation

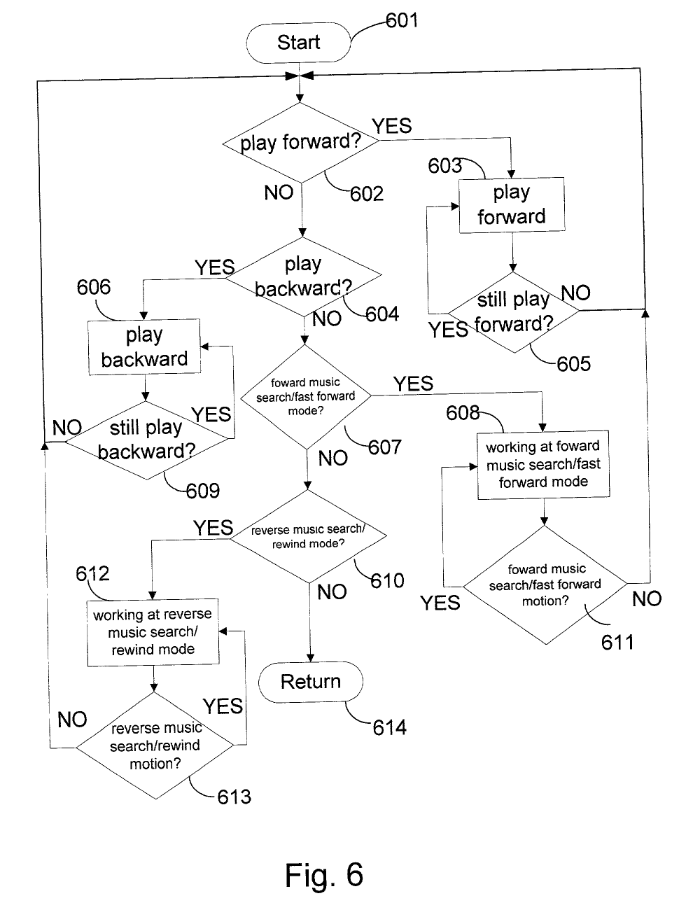

The DEAP 20 is interacting with the cassette player 40 via its magnetic head 210 and wheels 211 & 212. The motion detection mechanism 216 is monitoring the motion of the tape wheels 211 and 212 all the time. When a spin motion of the tape wheels 211 and/or 212 is detected, the motion detection mechanism 216 triggers the DEAP 20 to work under the tape simulation mode (describe in FIG. 6). By the spin speed detected from the tape wheels 211, 212, the DEAP 20 plays and/or simulates a regular cassette magnetic tape.

When normal play forward speed is detected from the tape wheels 211&212, the DEAP 20 plays the first music (any audio file) from the current location. The audio signal is sent to the magnetic head 210. The cassette player 40 picks up the signal and plays to the stereo speakers 407,408. While the play forward motion is continuously detected, the DEAP 20 plays the music sequentially one by one forward from the current location.

When normal play backward speed is detected from the tape wheels 211&212, the DEAP 20 plays the first music (any audio file) backward from the current location. The audio signal is sent to the magnetic head 210. The cassette player 40 picks up the signal and plays to the stereo speakers 407,408. While the play backward motion is continuously detected, the DEAP 20 plays the music sequentially one by one backward from the current location.

When forward music search speed is detected from the tape wheels 211&212, the DEAP 20 plays the first music (any audio file) from the current location for a few second. The audio signal is sent to the magnetic head 210. The cassette player 40 picks up the signal and plays to the stereo speakers 407,408. (Some cassette players do not have the music search feature. They simply work at fast forward mode) While the fast forward motion is continuously detected, the DEAP 20 plays the music sequentially one by one each for a few second forward from the current location, and the audio file location sign changes accordingly.

When reverse music search speed is detected from the tape wheels 211&212, the DEAP 20 plays the first music (any audio file) reverse from the current location for a few second. The audio signal is sent to the magnetic head 210. The cassette player 40 picks up the signal and plays to the stereo speakers 407,408. (Some cassette players do not have the music search feature. They simply work at rewind mode) While the reverse fast motion is continuously detected, the DEAP 20 plays the music sequentially one by one each for a few second reverse from the current location, and the audio file location sign changes accordingly.

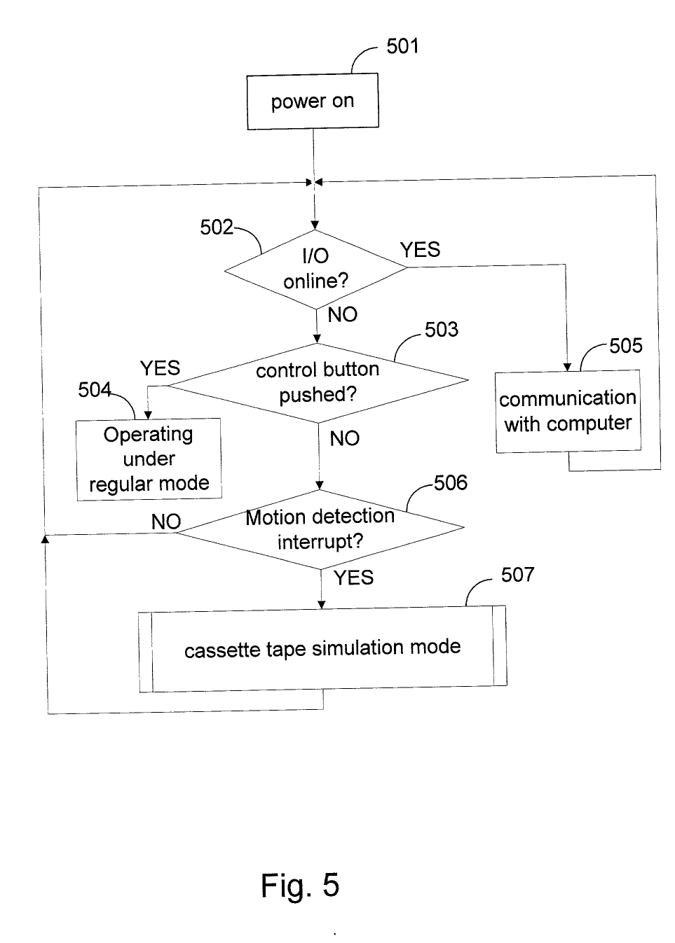

FIG. 5 operation

FIG. 5 is a flow chart representation of the operation of the digital electronic audio player of the present invention. When powered on (501), the system starts the regular self-test and then checks if the I/O is online (502) with a computer? If the system is online with the computer, it will switch to communication with the computer-working mode (505). After it is done communicating with the computer, system goes back to check the status. If the system is not online, the system continues to check if any of the control buttons is pushed (503)? If there is control button pushed, the system switches to operate under regular mode (504) like a regular digital electronic audio player. If there is no control button is pushed, the system checks if there is any tape wheels motion detection interrupt (506)? If there is a no motion of tape wheels detected, the system loops back to check if the system is online with a computer (502). If there is tape wheels motion detected, the system switches to cassette tape simulation mode process (507). When the cassette tape simulation mode process (507) is done, the system loops back to check if the system is online with a computer (502). The loop keeps continuously run as the main procedure of the digital electronic audio player of the present invention. An alternate main procedure is to put the system into waiting after the power on; the system switches into different operation according to the interrupt triggered by different process.

FIG. 6 operation

FIG. 6 is a flow chart representation of the operation of the digital electronic audio player working at the cassette tape simulation mode with the present invention. Once going to the cassette tape simulation mode process (601) which is handed over from 507 in FIG. 5, the system simulates the function of the cassette tape by checking the motion status of the wheels of play forward (602), play backward (604), forward music search/fast forward (607), reverse music search/rewind (610). If no motion status is detected, at the step 614 the system returns to main procedure.

When play forward motion is detected, the DEAP 20 plays the first audio file from the current location (603) while monitoring the play forward motion (605). If the play forward motion keeps presence, the system continues to play the current audio file, and when the current file ends it will continue to play consequential next file forward. When the play forward motion disappears, it means that cassette player switches to the other working mode, the system stops play the current audio file and goes back to check which mode is selected.

When play backward motion is detected, the DEAP 20 plays the first audio file backward from the current location (606) while monitoring the play backward motion (609). If the play backward motion keep presence, the system continues to play the current audio file, and when the current file ends it will continue to play consequential next file backward. When the play backward motion disappears, it means that cassette player switches to the other working mode, the system stops play the current audio file and goes back to check which mode is selected.

When forward music search/fast forward motion is detected, the DEAP 20 plays the first audio file from the current location (608) for a few second (pre-set music search period) while monitoring the forward music search/fast forward motion (611). If the forward music search/fast forward motion keeps presence, the system continues to play the current audio file, and when the pre-set music search period ends it will continue to play consequential next file forward for the next period. When the forward music search/fast forward motion disappears, it means that cassette player switches to the other working mode, the system stops play the current audio file and goes back to check which mode is selected.

When reverse music search/rewind motion is detected, the DEAP 20 plays the first audio file backward from the current location (612) for a few second (pre-set music search period) while monitoring the reverse music search/rewind motion (613). If the reverse music search/rewind motion keeps presence, the system continues to play the current audio file, and when the pre-set music search period ends it will continue to play consequential next file backward for the next period. When the reverse music search/rewind motion disappears, it means that cassette player switches to the other working mode, the system stops play the current audio file and goes back to check which mode is selected.

Because of the different feature of the audio chip 208, there may be some additional performance when working at music search mode. These features are optional pre-selected.

An alternate switching procedure is to switch the system work mode at the same checkpoint and switch to different working mode accordingly.

Conclusion, Ramifications, and Scope

Accordingly, the reader can see, I've provided a device that can take the advantage of both the regular digital electronic audio player and well-developed cassette player sound system. People can use existing audio system to play digital music, for example MP3 music. The cassette tape compatible feature make it possible for the DEAP of the present invention to be used in any standard cassette player, such as, car cassette tape stereo system, and home cassette players. The magnetic head couples the output of the digital audio circuit to the magnetic head of the cassette players as the signal input to them. Because the operations of the cassette player are relayed on the motion of the two tape wheel axles of the cassette player, the digital electronic audio player of the present invention performs the simulation of the cassette tape by detecting the motion of the wheels of the DEAP itself. More particular, people can use the control buttons of the cassette player to play the “tape”—the digital electronic audio player of the present invention, such as, play, forward, reverse, stop, and etc. For example, when play button is pushed, the axial of the cassette player spins in a regular play speed; thus spins the wheel in the digital electronic audio player; by detecting the spin of the wheel, the electronic audio player plays the music continually in the cassette player until the spin status of the wheel is changed. By the same operation features as the regular cassette tape, users feel very easy to use the DEAP. The DEAP provides a very high quality audio source to existing sound system.

Although the description above contains much specificity, these should not be construed as limiting the scope of the invention but as merely providing illustrations of some of the presently preferred embodiments of this invention. Various other embodiments and ramifications are possible within it's scope. For example:

A record mode control means can be easily added to the DEAP device to simulate the record operation of the regular cassette tape operation.

Thus the scope of the invention should be determined by the appended claims and their legal equivalents, rather than by the examples given.

What is claimed is:

1. A digital electronic audio player which can be used as normal digital electronic audio player as well as a simulating cassette tape for cassette tape player or recorder.

2. The body of the digital electronic audio player of claim 1 comprises a housing shaped compatible with industrial standard cassette tape, and can be inserted into cassette player for using similar to a cassette tape.

3. The body of the digital electronic audio player of claim 1 comprises a magnetic head installed inside the housing at a location for contacting with the magnetic head of a cassette tape player.

4. The body of the digital electronic audio player of claim 1 comprises a motion detection means inside the housing to simulate the motion performance of a regular cassette tape for the cassette tape player, and detect the motion of the status of the tape axles of the cassette player.

5. The motion detection means wherein claim 4 comprises two tape wheels having the same inner shape of the tape wheels of the regular cassette tape and other means to simulate the wheel of regular cassette tape and detect the motion of tape axels of a cassette player.

6. The body of the digital electronic audio player of claim 1 comprises a PCB assembly comprising everything needed for a regular digital electronic audio player.

7. The body of the digital electronic audio player of claim 1 comprises an extension connector's area for extension.

8. An extension adaptor for providing extra DC power, memory, and communication with computer for the digital electronic audio player of claim 1.

9. The extension adaptor of claim 8 comprises a PCB assembly comprising memory, I/O control circuit, connectors and communication port.

10. The extension adaptor of claim 8 comprises an extension connector's area for connecting to the extension connector's area of the digital electronic audio player of claim 7.

11. The extension adaptor wherein claim 8 comprises a power area comprising battery holder and DC connector for external power supply.
